(19) United States
(12) Patent Application Publication
(10) Pub. No.: US 2026/0309203 A1
(43) Pub. Date: Oct. 8, 2026

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Jens ROBRECHT, Nettersheim (DE)

(73) Assignees: thyssenkrupp Bilstein GmbH, Ennepetal (DE); thyssenkrupp AG, Essen (DE)

(21) Appl. No.: 19/478,719

(22) PCT Filed: Apr. 25, 2024
(86) PCT No.: PCT/EP2024/061348

§ 371 Date: Oct. 24, 2025

(30) Foreign Application Priority Data
Apr. 27, 2023 (DE) 10 2023 110 915.4
Apr. 27, 2023 (LU) LU103106

(51) Int. Cl. F16F 9/49

(52) U.S. Cl. CPC F16F 9/49; F16F 2222/12

(57) ABSTRACT

A vibration damper for a vehicle comprises: a damper tube filled with hydraulic fluid, a working piston connected to a piston rod and which is arranged so that it can move back and forth inside the damper tube, wherein the interior of the damper tube is divided by the working piston into a first working chamber on the piston rod side and a second working chamber remote from the piston rod, an additional piston which is attached at the piston rod, and a pressure stop assembly with a pressure stop receptacle, attached inside the damper tube, for receiving the additional piston in the pressure stage, wherein the pressure stop assembly has a piston ring which is attached axially movably inside the pressure stop receptacle and has a gap.

The invention relates to a vibration damper for a motor vehicle with a pressure stop assembly.

DE 10 2015 121 140 A1 discloses a hydraulic vibration damper with a hydraulic pressure stop. A hydraulic pressure stop usually serves for additional damping in the pressure stage of the vibration damper. To do this, in known vibration dampers an additional piston plunges into a pressure stop chamber and thus generates additional damping when the piston rod moves in the pressure direction. The components which interact during the pressure damping usually have to comply with very precise manufacturing tolerances in order, for example, to compensate transverse forces on the piston rod. The manufacturing of these components is therefore usually very costly. The structural chamber for a pressure stop inside the vibration damper is furthermore limited.

Starting therefrom, the object of the present invention is to provide a vibration damper with a pressure stop assembly which can be produced cost-effectively and can be assembled simply.

This object is achieved according to the invention by a vibration damper having the features of the independent device claim 1. Advantageous developments can be found in the dependent claims.

According to a first aspect, a vibration damper for a vehicle comprises a damper tube filled with hydraulic fluid, and a working piston connected to a piston rod and which is arranged so that it can move back and forth inside the damper tube, wherein the interior of the damper tube is divided by the working piston into a first working chamber on the piston rod side and a second working chamber remote from the piston rod. The vibration damper preferably also comprises a closure package which shuts off the damper tube fluidtightly on the piston rod side. The vibration damper furthermore comprises an additional piston which is attached at the piston rod, and a pressure stop assembly with a pressure stop receptacle, attached inside the damper tube, for receiving the additional piston in the pressure stage, wherein the pressure stop assembly has a piston ring which is attached axially movably inside the pressure stop receptacle and has a gap. The gap is preferably designed as an opening in the annular body of the piston ring such that the piston ring is preferably designed as a C-ring. The gap is in particular formed at the circumference and extends, for example, as a slot in an axial direction over the entire length and width of the piston ring.

The piston ring is preferably not attached at the piston rod and the additional piston and instead only inside the pressure stop receptacle. The pressure stop receptacle is preferably designed as an axial guide for the piston ring.

The vibration damper is, for example, a monotube or multi-tube vibration damper. For example, a multi-tube vibration damper for a vehicle comprises an outer tube and an inner tube arranged coaxially therewith, wherein a compensation chamber for receiving hydraulic fluid is formed between the outer tube and the inner tube, and a working piston which is connected to a piston rod and is arranged so that it can move back and forth inside the inner tube, wherein the interior of the inner tube is divided by the working piston into a first working chamber on the piston rod side and a second working chamber remote from the piston rod. The compensation chamber is preferably filled at least partially, in particular at the upper end, with a gas. The outer tube preferably forms at least partially the housing of the vibration damper. The inner surface of the inner tube is preferably designed as a guide for the working piston. The working piston preferably has a valve device by means of which the first and the second working chamber are connected to each other. Preferably no outer tube is provided in the case of a monotube vibration damper. The inner tube is referred to as a damper tube and, as described above with reference to the inner tube, receives the piston rod and the working piston.

In the case of a multi-tube vibration damper, the vibration damper has in particular a closure package which is designed and arranged to seal the interior of the outer tube fluidically on the piston rod side. The end of the inner tube on the piston rod side is preferably fastened at the closure package. The compensation chamber and the second working chamber are preferably sealed fluidically by means of a base piece at the end remote from the piston rod, opposite the closure package. The compensation chamber is preferably fluidically connected to the first or second working chamber via openings in the inner tube. For example, the compensation chamber is sealed with respect to the inner tube by means of a base element. A base valve which is attached in particular at the end of the inner tube remote from the piston rod is in particular arranged at the base piece. The second working chamber is preferably fluidically connected to the compensation chamber via the base valve. The base valve is preferably a non-return valve through which fluid can flow in both directions or just one direction. For example, the base valve is designed as a non-return valve in the rebound direction in the case of a movement of the piston in a direction out of the inner tube, and as an identifier-generating valve in the pressure direction in the case of a movement of the piston into the inner tube.

In the case of a monotube vibration damper, the vibration damper has in particular a closure package which is designed and arranged to seal the interior of the damper tube fluidically on the piston rod side. The end of the damper tube on the piston rod side is preferably fastened at the closure package. The closure package is preferably arranged coaxially with the piston rod and encloses the latter at its circumference. The interior of the damper tube is preferably sealed fluidically by means of an axially movable sealing element at the end remote from the piston rod, opposite the closure package. The sealing element preferably separates a gas chamber, adjoining it in an axial direction, from the working chamber filled with hydraulic fluid.

In the following description, the term vibration damper is understood to mean both a multi-tube vibration damper and a monotube vibration damper, wherein the damper tube is the inner tube of a multi-tube vibration damper.

The pressure stop assembly is preferably arranged inside the damper tube, in particular in that end region of the damper tube remote from the piston rod, and preferably comprises the pressure stop receptacle and the piston ring which is attached axially movably inside the pressure stop receptacle and preferably lies fluidtightly at least partially or completely against the inner wall of the pressure stop receptacle with its outer circumferential surface. The piston ring is preferably not fastened at the piston rod and the additional piston. The piston ring and the piston rod are in particular attached so that they can move relative to each other. The pressure stop assembly also comprises a pressure stage working chamber which is separated by the piston ring inside the damper tube, in particular the pressure stop receptacle. The additional piston is fastened at the piston rod so that it is fixed in position and is arranged relative to the working piston in the pressure direction.

A movement in the rebound direction is understood below to mean a movement in the direction of the closure package into that region of the shock absorber on the piston rod side, and a movement in the pressure direction to mean a movement in the direction of the base valve in that region of the shock absorber remote from the piston rod.

According to a first embodiment, the pressure stop assembly has a pressure stage working chamber which is separated by the piston ring inside the pressure stop receptacle and wherein the gap at least partially or completely forms a bypass channel between the pressure stage working chamber and the working chamber remote from the piston rod. The pressure stage working chamber is preferably formed between the piston ring and the base of the in particular hollow-cylindrical pressure stage receptacle. The bypass channel is preferably formed by the gap in the piston ring and the chamber between the external diameter of the additional piston and the internal diameter of the pressure stop receptacle.

In the pressure stage, the piston rod is moved in the pressure direction such that the additional piston lies against the piston ring and moves the latter in the pressure direction inside the pressure stage receptacle. The bypass channel enables a flow of hydraulic fluid from the pressure stage working chamber when the piston ring moves in the pressure direction and thus produces the damping of the piston rod movement in the pressure direction.

According to a further embodiment, the piston ring is arranged separately from the additional piston such that the additional piston is arranged so that it can move relative to the piston ring outside the pressure stop assembly. The piston ring is in particular not attached at the additional piston. The movements of the additional piston and the piston ring are coupled only inside the pressure stop receptacle. The arrangement of the piston ring separately from the additional piston inside the pressure stop receptacle offers the advantage of simple and quick assembly of the piston ring.

According to a further embodiment, the pressure stop assembly has a spring element which is arranged inside the pressure stop receptacle and lies against the piston ring. The spring element is preferably arranged between the piston ring and the base of the hollow-cylindrical pressure stop receptacle and lies against it with its respective end regions. The spring element is, for example, a helical spring. The spring element preferably lies in the untensioned or slightly pretensioned state against the piston ring and the base of the pressure stop receptacle. The piston ring is moved by the spring element when the additional piston moves in the rebound direction back into the starting position which is preferably situated at that end of the pressure stop receptacle which faces in the rebound direction.

According to a further embodiment, the pressure stop receptacle has a connecting region at which the pressure stop receptacle is connected to the damper tube, in particular so that it is fixed in position, in particular by means of a force-fitting connection, a form-fitting connection and/or a substance-to-substance bond. The connecting region is preferably formed at that end region of the pressure stop receptacle which faces in the direction of the working piston and is connected in particular fluidtightly to the inner tube. In particular, the connecting region of the pressure stop receptacle has a larger external diameter than the remainder of the region, extending from the connecting region in the pressure direction, of the pressure stop receptacle. For example, the pressure stop receptacle has a plurality of connecting regions which are preferably arranged spaced apart from one another circumferentially such that hydraulic fluid can flow between adjacent connecting regions. The pressure stop receptacle preferably has, outside the connecting region, an external diameter which is smaller than the internal diameter of the damper tube such that the hydraulic fluid can flow between the damper tube and the pressure stop receptacle. The pressure stop receptacle is preferably connected to the damper tube in a form-fitting fashion, in a substance-to-substance-bonded fashion and/or in a force-fitting fashion. In particular, the pressure stop receptacle is attached at the damper tube at the connecting regions by means of spot welds. The fastening of the pressure stop receptacle at individual connecting regions, in particular via spot welds, offers a simple option for the fastening, wherein a fluid flow between the connecting regions is simultaneously enabled.

According to a further embodiment, an annular chamber through which the hydraulic fluid can flow is formed between the pressure stop receptacle and the damper tube. The annular chamber preferably forms a fluidic connection between the working chamber remote from the piston rod and the base valve, wherein the pressure stop receptacle is bypassed. In normal operation, where the additional piston is not in the pressure stop receptacle, the pressure stop receptacle thus does not constitute an obstacle to the flow and has essentially no influence on the behavior of the vibration damper. Also in the operating state in which the additional piston is inside the pressure stop receptacle, the pressure stop receptacle does not constitute an obstacle to the flow such that a flow to the base valve is enabled.

According to a further embodiment, the pressure stop receptacle is designed as hollow-cylindrical.

According to a further embodiment, the piston ring is formed from a plastic. The piston ring is preferably manufactured by means of plastic injection molding. Forming the piston ring from a plastic provides cost-effective manufacturing of the piston ring.

According to a further embodiment, the piston ring has a first annular region and a second annular region adjoining it in the pressure direction, and wherein the first annular region has a smaller internal diameter than the second annular region. The first annular region preferably forms that end of the piston ring which faces in the rebound direction, and the second annular region preferably forms that end of the piston ring which faces in the pressure direction. The piston ring preferably consists only of the first and the second annular region. The first and the second annular region preferably have in each case a constant internal diameter. In particular, the first and the second annular region have an identical external diameter which is in particular constant. The piston ring preferably has an L-shaped cross section. The annular regions preferably have in each case an essentially rectangular cross section. That end side of the first annular region which faces in the direction of the additional piston preferably forms a support surface for the additional piston in the pressure stage. The inner side of the second annular region forms in particular a support surface for the spring element. The external diameter of the spring element is preferably greater than or equal to the internal diameter of the piston ring, in particular of the second annular region of the piston ring, such that the spring element is connected to the piston ring, for example, in a form-fitting and/or force-fitting fashion.

According to a further embodiment, the additional piston has an external diameter which is smaller than the internal diameter of the pressure stop receptacle such that a hydraulic fluid can flow between the pressure stop receptacle and the additional piston. Fluidtight shutting-off of the pressure stage working chamber is preferably achieved only between the piston ring and the additional piston.

The additional piston preferably comprises a valve body with at least one or a plurality of axial through bores which are covered at least partially or completely on the piston rod side by valve disks. The valve disks are preferably pretensioned in such a way that, above a specified pressure in the pressure stage working chamber, they allow a flow from the pressure stage working chamber through the through bores and into the second working chamber. The through bores together with the valve disks thus prevent a rise in pressure in the pressure stage working chamber which exceeds a specified value. The bypass channel is provided in addition to the through bores and offers an additional flow channel when the additional piston moves in the pressure direction. The bypass channel is formed in particular between the valve body and the pressure stop receptacle, and by the gap.

The valve body and the valve disks are preferably connected via a connecting element such as a screw element or a rivet, for example with a washer.

According to a further embodiment, the piston ring has a plurality of recesses in particular in addition to the gap. The recesses are formed, for example, in the outer side of the piston ring and are in particular uniformly spaced apart from one another preferably circumferentially.

Opposite recesses are preferably formed identically. The recesses form in particular additional flow passages for the hydraulic fluid.

According to a further embodiment, the pressure stop receptacle has an axial stop which forms a stop for limiting the movement of the piston ring in an axial direction. The pressure stop receptacle has, for example, a plurality of axial stops. The axial stop is designed, for example, as a radially inward extending projection and forms a stop for limiting the movement of the piston ring in an axial direction, in particular in the rebound direction. The pressure stop receptacle preferably has one, two, three or more axial stops which are arranged, for example, uniformly spaced apart from one another circumferentially.

According to a further embodiment, the pressure stop receptacle has a bypass opening which forms a bypass route with the additional piston and/or the external diameter of the piston ring. The bypass opening is preferably formed at that end of the pressure stop receptacle on the piston rod side. In particular, the bypass opening extends from the end on the piston rod side up to no more than 70%, in particular 50%, of the length of the pressure stop receptacle. The bypass route is preferably designed and arranged in such a way that it fluidically interconnects the pressure stage working chamber and that working chamber of the damper tube which is remote from the piston rod. The bypass route is preferably limited by the external diameter of the piston ring, the external diameter of the additional piston and of the pressure stop receptacle, in particular of the at least one bypass opening in the pressure stop receptacle, such that the hydraulic fluid preferably flows past the additional piston and into the working chamber remote from the piston rod. Such a bypass route enables precise setting of the damping of the additional piston in the pressure stage, in particular as a function of the position of the piston rod. The bypass route is produced directly, when the pressure stop assembly is activated, in particular when the piston ring moves in the pressure direction, by a bypass opening at that end of the pressure stop receptacle on the piston rod side, as a result of which soft damping of the pressure stage can initially be set. The bypass opening is preferably designed in such a way that it forms just an indentation at the inner wall of the pressure stop receptacle but does not extend through the wall of the pressure stop receptacle.

According to a further embodiment, the bypass opening is designed in such a way that its flow cross section reduces in the pressure direction. The bypass opening is preferably designed as a notch in the end side of the pressure stop receptacle, wherein the area of the bypass opening reduces in the pressure direction along the pressure stop receptacle. It is likewise conceivable that the bypass opening extends in the pressure direction, starting from the level of the connecting regions. The bypass route formed by the bypass opening has a flow cross section which reduces when the additional piston moves in the pressure direction. As a result, the damping of the additional piston is increased in the case of movement in the pressure direction and, for example, progressive damping is thus achieved. There are preferably no bypass openings formed in that region of the pressure stop receptacle remote from the piston rod. Maximum damping is thus set before the additional piston abuts the base of the pressure stop receptacle, in particular before the end of the maximum stroke of the vibration damper in the pressure stage. For example, the pressure stop receptacle has a plurality of bypass openings. The bypass route is preferably formed by all the bypass openings. For example, the bypass openings are arranged offset relative to one another circumferentially. In particular, the bypass openings are arranged homogeneously distributed over the circumference of the pressure stop receptacle, in particular uniformly spaced apart from one another. Bypass openings circumferentially opposite each other or all the bypass openings are in particular designed identically. This enables as uniform and progressive damping as possible of the additional piston via that surface of the piston ring which faces in the direction of the base piece.

According to a further embodiment, the pressure stop receptacle has at least one or a plurality of recesses which extend in an axial direction from that end of the pressure stop receptacle on the piston rod side. The connecting regions for connecting the pressure stop receptacle to the inner tube are preferably arranged circumferentially between the recesses. The recesses are designed, for example, as semi-circular and in particular are arranged preferably uniformly spaced apart from one another circumferentially. The recesses are, for example, designed identically. The recesses preferably serve to chamber the connecting regions apart from one another.

### DESCRIPTION OF THE DRAWINGS

The invention will be explained in detail below on the basis of a plurality of exemplary embodiments with reference to the attached Figures.

FIG. 1 shows a schematic illustration of a vibration damper in a view in longitudinal section according to an exemplary embodiment.

FIG. 2 shows a schematic illustration of a subsection of a vibration damper in a view in longitudinal section according to a further exemplary embodiment.

FIG. 3 shows a schematic illustration of a subsection of a vibration damper in the pressure stage in a view in longitudinal section according to a further exemplary embodiment.

FIG. 4 shows a schematic illustration of a piston ring in a perspective view according to a further exemplary embodiment.

FIG. 5 shows a schematic illustration of a subsection of a pressure stop receptacle in a perspective view according to a further exemplary embodiment.

FIG. 6 shows a schematic illustration of a subsection of a pressure stop receptacle in a perspective view according to a further exemplary embodiment.

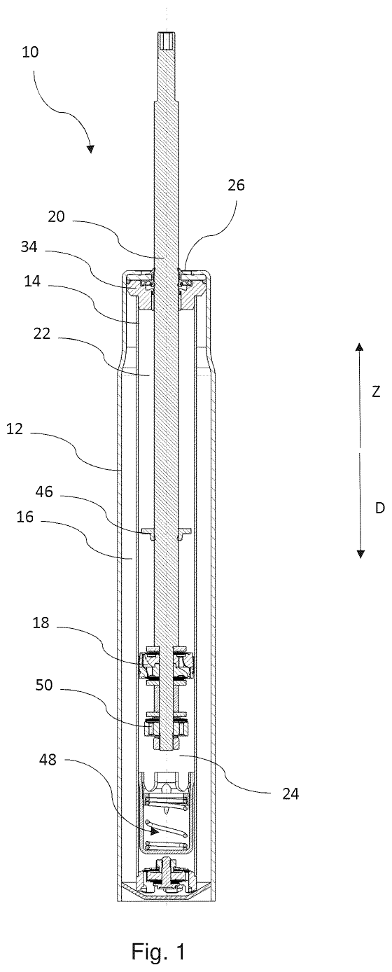

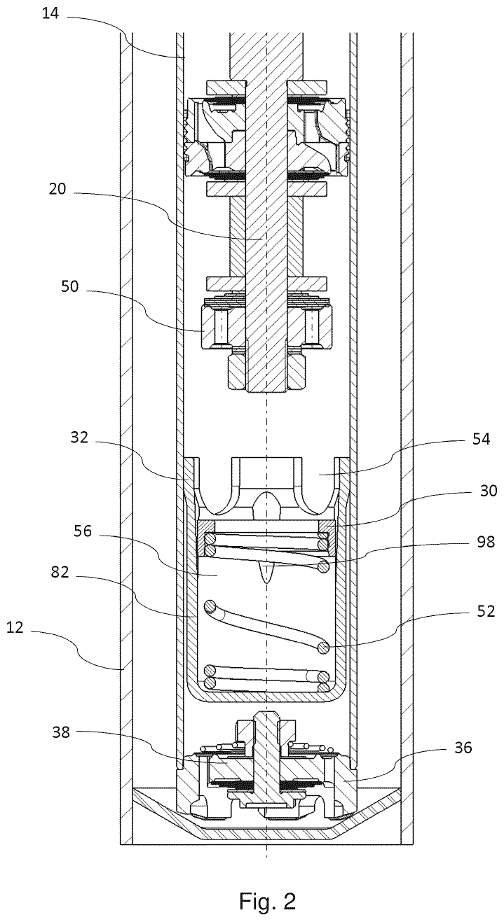

FIG. 1 shows a vibration damper 10, wherein the vibration damper 10 is, for example, a multi-tube vibration damper, for example a twin-tube vibration damper. FIG. 2 shows a section of the vibration damper in FIG. 1. The vibration damper 10 has an outer tube 12 which forms an outer surface, in particular a housing, of the vibration damper 10. Arranged inside the outer tube 12, coaxially with the latter, is a damper tube 14 which is also referred to as an inner tube 14. Formed between the outer tube 12 and the inner tube 14 is a compensation chamber 16 which is preferably at least partially or completely filled with a hydraulic fluid. The compensation chamber 16 is, for example, partially filled with a gas.

A working piston 18 connected to a piston rod 20 is arranged inside the inner tube 14 in such a way that it can move inside the inner tube 14, wherein the inner tube 14 is preferably designed as a guide for the working piston 18. The working piston 18 preferably has a valve device. The valve device comprises, for example, a rebound stage valve for damping the movement of the piston in the rebound stage, and a pressure stage valve for damping the movement of the piston in the pressure stage. The valves are preferably formed in each case by a through opening through the piston and a valve disk stack. The working piston 18 divides the interior of the inner tube 14 into a first working chamber 22 which is arranged on the piston rod side, and a second working chamber 24 which is arranged remotely from the piston rod. The piston rod 20 can preferably be connected to the vehicle body with its end projecting from the damper tube 14. The working piston 18 is fastened at the piston rod preferably so that it is fixed in position. The vibration damper 10 comprises an additional piston 50 which is likewise attached at the piston rod 20 so that it is fixed in position, wherein the additional piston 50 is attached at a region, adjoining the working piston in the pressure direction D, of the piston rod 20. The additional piston 50 is preferably attached at that end of the piston rod 20 which is arranged inside the damper tube 14. An in particular sleeve-shaped reinforcement, which is attached coaxially with the piston rod 20 around the latter and is fastened at the piston rod 20, is attached, for example, between the working piston 18 and the additional piston 50.

The interior of the outer tube 12 is fluidically sealed on the piston rod side by means of a closure package 34. Opposite the closure package 34, at the end remote from the piston rod, the compensation chamber 16 is fluidically sealed by means of a base piece 36. The inside of the damper tube 14, in particular the second working chamber 24, is preferably likewise fluidically sealed by means of the base piece 36. It is likewise conceivable that a further base element is provided separately from the base piece, which seals the outer tube 12. Arranged at the base piece 36, by way of example, is a base valve 38 which is attached in particular at that end of the inner tube 14 remote from the piston rod. The base valve 38 is preferably a non-return valve through which fluid can flow in both directions or just one direction. The second working chamber 24 is preferably fluidically connected to the compensation chamber 16 via the base valve 38. That end of the inner tube 14 which is on the piston rod side is preferably fastened at the closure package 34.

The outer tube 12 is preferably designed cylindrically and optionally has a smaller diameter at the end region on the piston rod side. The outer tube 12 is fluidically sealed with respect to the piston rod 20 via a seal 26 attached at that end of the outer tube 14 which is on the piston rod side.

The vibration damper 10 comprises, for example, a rebound stop 46 which is attached at the piston rod 20 so that it is fixed in position. The rebound stop 46 is designed, for example, as annular and arranged between the working piston 18 and the closure package 34 inside the first working chamber 22. The rebound stop 46, in particular the end surface facing in the direction of the closure package 34, forms a stop surface for lying against the closure package 34 when the piston rod moves in the rebound direction Z. The rebound stop 46 serves to limit the movement of the piston rod in the rebound direction Z. A flow gap, through which the hydraulic fluid can flow when the piston rod moves, is preferably formed between the rebound stop 46 and the inner wall of the damper tube 14.

The vibration damper 10 comprises, for example, a pressure stop assembly 48 which is arranged inside the damper tube 14, in particular in that end region of the damper tube 14 remote from the piston rod. The pressure stop assembly 48 preferably comprises a pressure stop receptacle 82 and a piston ring 30 which is attached axially movably inside the pressure stop receptacle 82 and preferably lies fluidtightly at least partially or completely against the inner wall of the pressure stop receptacle 82 with its outer circumferential surface. The piston ring 30 is preferably attached axially movably inside the pressure stop receptacle 82 in such a way that the pressure stop receptacle 82 forms a guide for the piston ring 30. The piston ring 30 is, for example, not fastened at the piston rod 20 and the additional piston 50. The pressure stop assembly 48 also comprises in particular a spring element 52 which is preferably arranged between the piston ring 30 and the base of the hollow-cylindrical pressure stop receptacle 82 and lies against the latter with its respective end regions. The spring element 52 is; for example, a helical spring. The piston ring 30 separates in particular a pressure stage working chamber 56 inside the pressure stop receptacle 82. The pressure stage working chamber 56 is preferably arranged inside the pressure stop receptacle 82 completely behind the piston ring 30 in the pressure direction D. The pressure stop receptacle 82 is, for example, designed hollow-cylindrically and is attached in particular at the inner tube 14. The pressure stop receptacle 82 preferably lies partially against the inner wall of the damper tube 14 with its external diameter. The pressure stop receptacle 82 has, for example, at its end region facing in the direction of the working piston 18, a connecting region 32 which is connected to the inner tube 14 preferably so that it is fixed in position. In particular, the connecting region 32 of the pressure stop receptacle 82 has a larger external diameter than the remainder of the region, extending in particular from the connecting region in the pressure direction D, of the pressure stop receptacle 82. The pressure stop receptacle 82 preferably has an external diameter outside the connecting region which is smaller than the internal diameter of the damper tube 14 such that the hydraulic fluid can flow between the damper tube 14 and the pressure stop receptacle 82. The pressure stop receptacle 82 is preferably connected to the inner tube 14 in a form-fitting fashion, a substance-to-substance-bonded fashion and/or a force-fitting fashion.

The piston ring 30 is arranged in particular axially between the additional piston 50 and the base of the pressure stop receptacle 82. The spring element 52 lies in the untensioned or slightly pretensioned state against the piston ring 30 and the base of the pressure stop receptacle 82.

During operation of the shock absorber 10 and when the piston rod 20 moves in the pressure direction D, the additional piston 50 is moved into the pressure stop receptacle 82 and presses the piston ring 30 in the pressure direction D in the direction of the base of the pressure stop receptacle 82, wherein the spring element 52 is tensioned. When the piston rod 20 subsequently moves in the rebound direction Z, the piston ring 30 is pressed in the rebound direction Z by means of the spring element 52 and preferably moves into its starting position at the open end region of the pressure stop receptacle 82.

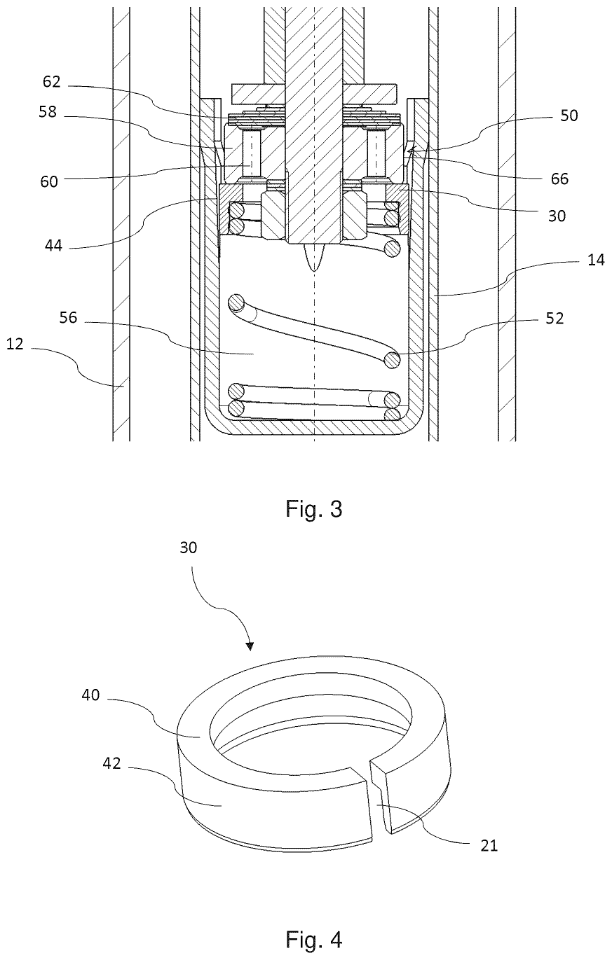

FIG. 3 shows a subsection of a shock absorber 10 according to a further exemplary embodiment, wherein FIG. 3 shows the shock absorber 10 in a position in which the additional piston 50 lies against the piston ring 30. The essential elements of FIG. 3 correspond to those of FIGS. 1 and 2.

FIG. 4 shows a piston ring 30. The piston ring 30 is, for example, designed as a C-ring, wherein the piston ring 30 has an opening which is preferably designed as a slot, in particular a circumferential gap 21 in the annular body of the piston ring 30 which is a complete circumferential gap in the annular piston ring 30. The piston ring 30 preferably has an L-shaped cross section. In particular, the piston ring 30 has a first annular region 40 and a second annular region 42 adjoining it in the pressure direction D, which in each case have an essentially rectangular cross section. The first annular region 40 preferably extends radially inward beyond the second annular region 42. In particular, the first annular region 40 has a smaller internal diameter than the second annular region 42. The end side, facing in the direction of the additional piston 50, of the first annular region 40 preferably forms a support surface for the additional piston 50 in the pressure stage. The piston ring 30 preferably consists only of the first and the second annular region 40, 42. The opening extends in particular in an axial direction, preferably parallel to the center axis of the piston ring 30, through the first and the second annular region 40, 42. and preferably forms a complete gap in the annular piston ring 30. The inner side of the second annular region 42 forms, for example, a support surface for the spring element 52. The external diameter of the spring element 52 is preferably greater than or equal to the internal diameter of the piston ring 30, in particular of the second region 42 of the piston ring 30, such that the spring element 52 is connected to the piston ring 30 in, for example, a form-fitting fashion and/or a force-fitting fashion. That surface of the first annular region 40 which faces in the direction of the spring element 52 likewise preferably forms a support surface for the spring element 52.

In the position shown in FIG. 3, the additional piston 50 lies against the piston ring 30. In a position not illustrated in FIG. 3, the piston rod 20 is moved further in the pressure direction D, wherein the additional piston 50 and the piston ring 30 are moved with the piston rod 20 in the pressure direction D and the spring element 52 is tensioned such that it stresses the piston ring 30 in the rebound direction Z with a force which preferably increases with movement in the pressure direction D. In addition, sealing of the additional piston at the piston ring preferably takes place such that, when the piston ring 30 moves in the pressure direction D, the whole surface consisting of the piston ring, the additional piston, and the piston rod is stressed with a force resulting from the hydraulic pressure.

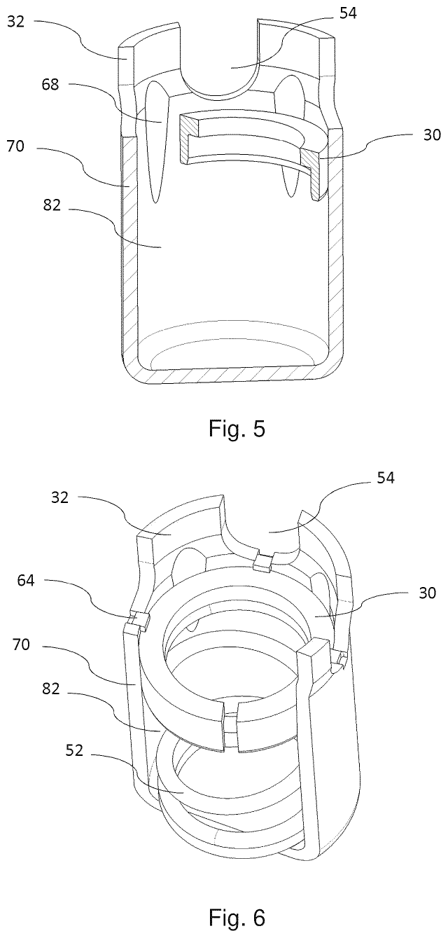

FIGS. 1 to 3 also show a bypass route 44 through which hydraulic fluid can flow from the pressure stage working chamber 56 into the working chamber 24 remote from the piston rod. The bypass route 44 is described in detail with reference to FIG. 5.

The additional piston 50 comprises a valve body 58 with at least one or a plurality of axial through bores 60 which are covered by valve disks 62. The valve disks 62 are attached at that end of the valve body 58 on the piston rod side and are pretensioned in such a way that they allow a flow from the pressure stage working chamber 56, through the through bores 60 and into the second working chamber 24 above a specified pressure in the pressure stage working chamber 56. The through bores 60, together with the valve disks 62, thus prevent a rise in pressure in the pressure stage working chamber 56 which exceeds a specified value. The valve body 58 or a disk (not illustrated) attached at the valve body preferably lies fluidtightly against the piston ring. The piston ring 30 is designed and arranged in such a way that it additionally fits fluidtightly against the inner wall of the damper tube 14. The additional piston 50 preferably has an external diameter which is smaller than the internal diameter of the pressure stop receptacle 82 such that a hydraulic fluid can flow between the pressure stop receptacle 82 and the additional piston 50. The gap 21 in the piston ring 30 preferably forms a bypass channel 66 between the pressure stage working chamber 56 and the working chamber 24 remote from the piston rod. The bypass channel 66 preferably comprises the gap 21 in the piston ring 30 and the chamber between the additional piston 50 and the pressure stop receptacle 82.

FIG. 5 shows a subsection of the piston ring 30 in the pressure stop receptacle 82. The pressure stop receptacle 82 is, for example, designed cylindrically and has a bypass opening 68 which extends through the wall 70 of the pressure stop receptacle 82, and a bypass route 44 for hydraulic fluid between the piston ring 30 and in particular the additional piston 50 and the inner wall of the damper tube 14. The pressure stop receptacle 82 furthermore has, for example, at least one or a plurality of recesses 54 which extend in an axial direction from that end of the pressure stop receptacle 82 which is on the piston rod side. The recesses 54 preferably have a semi-circular end region and extend in particular at least over the axial length of the connecting region 32 or beyond the latter. The recesses 54 are, for example, arranged so that they are uniformly spaced apart from one another circumferentially. The connecting regions 32 for connecting the pressure stop receptacle 82 to the inner tube 14 are preferably arranged circumferentially between the recesses 54.

The bypass opening 68 extends, for example, from the connecting region 32 of the pressure stop receptacle 82 as far as approximately the axial center of the pressure stop receptacle 82. The bypass opening 68 is, for example, formed so that it tapers in the pressure direction such that the flow cross section of the bypass opening 68 reduces in the pressure direction. The pressure stop receptacle 82 has, for example, two, three, four or more bypass openings 68 which are in particular formed identically. The bypass openings 68 are preferably arranged opposite one another, in particular offset circumferentially by 180° relative to one another. The bypass opening 68 forms the bypass route 44 through which hydraulic fluid can flow from the pressure stage working chamber 56 between the piston ring 30, the additional piston 50, and the inner wall of the pressure stop receptacle 82 in which is provided the bypass opening 68 in the form of a notch. The design of the bypass opening 68 so that it tapers in the pressure direction D ensures, for example, progressive damping of the movement of the additional piston 50 in the pressure direction D because the flow cross section of the bypass route 44 reduces when the additional piston 50 moves in the pressure direction D.

FIG. 6 shows a subsection of the pressure stop receptacle 82 with the piston ring 30 and the spring element 52. The pressure stop receptacle 82 has, for example, a plurality of axial stops 64 which are designed, for example, as radially inward extending projections and form a stop for limiting the movement of the piston ring 30 in an axial direction, in particular in the rebound direction Z. The pressure stop receptacle 82 preferably has at least one, two, three or more axial stops 64 which are, for example, arranged uniformly spaced apart from one another circumferentially. The axial stops 64 adjoin, for example, in each case one recess 54 in the pressure direction D.

### LIST OF REFERENCE SIGNS

10 vibration damper
12 outer tube
14 damper tube/inner tube
16 compensation chamber
18 working piston
20 piston rod
21 gap
22 first working chamber
24 second working chamber
26 seal
30 piston ring
32 connecting region
34 closure package
36 base piece
38 base valve
40 first annular region
42 second annular region
44 bypass route
46 rebound stop
48 pressure stop assembly
50 additional piston
52 spring element
54 recess
56 pressure stage working chamber
58 valve body
60 through bores
62 valve disks
64 axial stop
66 bypass channel
68 bypass opening in the pressure stop receptacle
70 wall of the pressure stop receptacle
82 pressure stop receptacle
Z rebound direction
D pressure direction

1-15. (canceled)

16. A vibration damper for a vehicle, comprising:
a damper tube filled with hydraulic fluid;
a working piston connected to a piston rod and which is arranged so that it can move back and forth inside the damper tube, wherein the interior of the damper tube is divided by the working piston into a first working chamber on the piston rod side and a second working chamber remote from the piston rod;
an additional piston which is attached at the piston rod; and
a pressure stop assembly with a pressure stop receptacle, attached inside the damper tube, for receiving the additional piston in a pressure stage;
wherein the pressure stop assembly has a piston ring which is attached axially movably inside the pressure stop receptacle and has a gap.

17. The vibration damper as claimed in claim 16, wherein the pressure stop assembly comprises a pressure stage working chamber which is separated by the piston ring inside the pressure stop receptacle and wherein the gap forms a bypass channel between the pressure stage working chamber and the working chamber remote from the piston rod.

18. The vibration damper as claimed in claim 16, wherein the piston ring is arranged separately from the additional piston such that the additional piston is arranged so that it can move relative to the piston ring outside the pressure stop assembly.

19. The vibration damper as claimed in claim 16, wherein the pressure stop assembly has a spring element which is arranged inside the pressure stop receptacle and lies against the piston ring.

20. The vibration damper as claimed in claim 16, wherein the pressure stop receptacle has a connecting region at which the pressure stop receptacle is connected to the damper tube.

21. The vibration damper as claimed in claim 16, wherein an annular chamber through which the hydraulic fluid can flow is formed between the pressure stop receptacle and the damper tube.

22. The vibration damper as claimed in claim 16, wherein the pressure stop receptacle is designed as hollow-cylindrical.

23. The vibration damper as claimed in claim 16, wherein the piston ring is formed from a plastic.

24. The vibration damper as claimed in claim 16, wherein the piston ring has a first annular region and a second annular region adjoining it in the pressure direction, and wherein the first annular region has a smaller internal diameter than the second annular region.

25. The vibration damper as claimed in claim 16, wherein the additional piston has an external diameter which is smaller than the internal diameter of the pressure stop receptacle such that a hydraulic fluid can flow between the pressure stop receptacle and the additional piston.

26. The vibration damper as claimed in claim 16, wherein the piston ring has a plurality of recesses.

27. The vibration damper as claimed in claim 16, wherein the pressure stop receptacle has an axial stop which forms a stop for limiting the movement of the piston ring in an axial direction.

28. The vibration damper as claimed in claim 16, wherein the pressure stop receptacle has a bypass opening which forms a bypass route with the additional piston and the piston ring.

29. The vibration damper as claimed in claim 16, wherein the bypass opening is designed in such a way that its flow cross section reduces in the pressure direction.

30. The vibration damper as claimed in claim 16, wherein the pressure stop receptacle has at least one or a plurality of recesses which extend in an axial direction from that end of the pressure stop receptacle on the piston rod side.
